(19) United States
(12) Patent Application Publication
(10) Pub. No.: US 2025/0019525 A1
(43) Pub. Date: Jan. 16, 2025

(54) Rubber Blends Containing Unsaturated Waxes And Use Thereof

(71) Applicant: ExxonMobil Technology and Engineering Company, Annandale, NJ (US)

(72) Inventors: Madelyn Bekker, Houston, TX (US); Venkatesh Murthy, Vijayanagar (IN); Sushil K. Mandot, Bengaluru (IN)

(73) Assignee: ExxonMobil Technology and Engineering Company, Annandale, NJ (US)

(21) Appl. No.: 18/221,312

(22) Filed: Jul. 12, 2023

(51) Int. Cl. C08L 9/00; B60C 1/00; C08L 7/00

(52) U.S. Cl. CPC C08L 9/00; B60C 1/0025; C08L 7/00

(57) ABSTRACT

Rubber blends may comprise at least one rubber compound, and at least one wax mixed with the at least one rubber compound, and wherein the at least one wax comprises an unsaturated wax. Suitable unsaturated waxes may include, but are not limited to C₁₈₊ linear alpha olefins (LAOs), LAO dimers formed from C₁₈₊ LAOs and having an internal olefin, or any combination thereof. The C₁₈₊ LAOs may be C₂₀-C₂₄ LAOs or C₂₄₊ LAOs. The rubber blends may be used in forming various rubber articles and in forming at least a portion of a tire, such as a tire sidewall containing a vulcanized rubber blend.

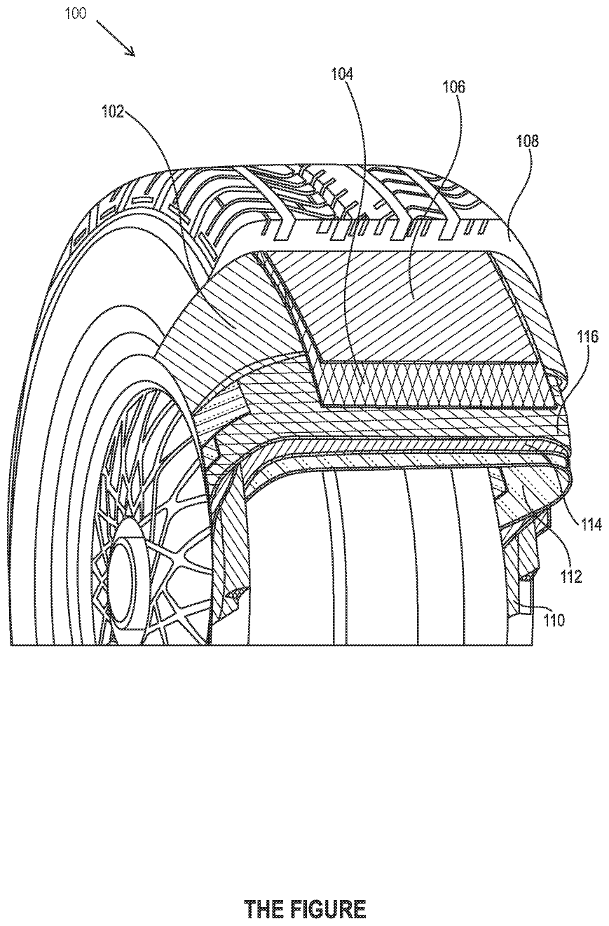

### FIELD

The present disclosure relates to rubber blends and, more particularly, wax-containing rubber blends that may afford anti-ozonant protection in tires and other rubber-based articles.

### BACKGROUND

Rubber compounds may be degraded by extended exposure to ozone during operational use, particularly under high-temperature operating conditions and in the presence of sunlight. Degradation of the rubber compounds by ozone exposure may occur through ozone attack upon diene-derived double bonds. As a result of excessive ozone exposure, an initially elastic rubber matrix may transform into a highly brittle form that undergo failure or otherwise become unsuitable for operational use, such as in a tire. Cracking upon excessive exposure to ozone may also be a predominant failure mode.

To increase ozone resistance and workability of rubber compounds, a wax may be blended therewith. Other anti-ozonant compounds may also be used in combination with a wax. Waxes are believed to facilitate ozone protection by forming a protective barrier layer upon the rubber surface. Paraffin and microcrystalline waxes are frequently used for this purpose. Paraffin waxes, including both natural waxes and synthetic waxes like Fischer-Tropsch waxes or petroleum-derived waxes, are typically straight-chain saturated hydrocarbons having a molecular weight of approximately 350-620 and exhibiting a melting point of approximately 38-80° C. Microcrystalline waxes are typically branched saturated hydrocarbons having a molecular weight of approximately 490-800 and exhibiting a melting point of approximately 57-100° C.

The global annual demand for waxes used in making tires is estimated at 300 million pounds and continues to grow. Unfortunately, the paraffin and microcrystalline waxes that are commonly used in formulating rubber blends are becoming less readily available due to ongoing supply chain issues, increasing costs, and changing manufacturing lines worldwide. As such, it is becoming ever more difficult for wax suppliers to keep up with the growing demand for making various types of rubber articles.

### SUMMARY

In some aspects, the present disclosure provides rubber blends comprising at least one rubber compound; and at least one wax mixed with the at least one rubber compound; wherein the at least one wax comprises an unsaturated wax.

Rubber articles may comprise the rubber blends. In some aspects, the present disclosure provides tires comprising the rubber blends. The tires comprise a sidewall formed from a rubber blend that is vulcanized and comprises: at least one rubber compound; and at least one wax mixed with the at least one rubber compound; wherein the at least one wax comprises an unsaturated wax.

These and other features and attributes of the disclosed methods and compositions of the present disclosure and their advantageous applications and/or uses will be apparent from the detailed description which follows.

### BRIEF DESCRIPTION OF THE DRAWINGS

The following FIGURE is included to illustrate certain aspects of the present disclosure, and should not be viewed as an exclusive embodiment. The subject matter disclosed is capable of considerable modifications, alterations, combinations, and equivalents in form and function, as will occur to one having ordinary skill in the art and having the benefit of this disclosure.

To assist one of ordinary skill in the relevant art in making and using the subject matter hereof, reference is made to the appended drawing, wherein:

The FIGURE is a diagram of a portion of an illustrative tire.

### DETAILED DESCRIPTION

The present disclosure relates to rubber blends and, more particularly, wax-containing rubber blends that may afford anti-ozonant protection in tires and other articles.

As discussed above, waxes are commonly used in rubber blends to improve ozone resistance and workability thereof. Common waxes utilized in rubber blends include paraffin waxes and microcrystalline waxes. Unfortunately, these types of waxes are becoming less readily available, and it is becoming ever more difficult to keep up with growing demand in the rubber industry.

The present disclosure provides alternative waxes for use in rubber blends. Specifically, the present disclosure provides rubber blends comprising at least one unsaturated wax as a full or partial replacement for saturated hydrocarbon waxes. In the disclosure herein, suitable unsaturated waxes may be linear alpha olefins (LAOs) within a targeted size range and/or dimerized linear alpha olefins (LAO dimers) in which an internal double bond remains in the dimeric structure, in contrast to a terminal double bond as found in the LAOs themselves. Advantageously, such unsaturated waxes may satisfactorily replace at least a portion of the saturated hydrocarbon waxes in a rubber blend to realize a comparable or even superior degree of ozone resistance and other beneficial properties, such as excellent rheology and other physical performance parameters. For example, the unsaturated waxes may decrease viscosity, increase scorch and crack resistance, improve crack growth resistance and fatigue life, and provide internal lubrication for forming the wax blends and ease of mold release when forming wax-containing articles. By virtue of their unsaturation and different physical properties compared to saturated hydrocarbon waxes (e.g., differing combinations of molecular weight, melting point, and viscosity, for instance), unsaturated waxes may afford complementary physical properties in rubber blends of the disclosure herein.

In addition to the foregoing advantages, the size of the LAOs may be varied as well to afford further tailoring of the wax properties and/or the properties of the rubber blends resulting therefrom. Depending on the desired end properties of the unsaturated wax and/or the rubber blend, suitable LAOs may include C₁₈-C₂₄ LAOs (e.g., C₂₀-C₂₄ LAOs) and/or C₂₄₊ LAOs, and their corresponding LAO dimers. Advantageously, all of these unsaturated waxes may be readily accessed from an in-common source of LAOs. Properties of the LAOs and LAO dimers and rubber blends obtained therefrom, are addressed in more detail hereinbelow.

In addition to affording different physical properties than saturated hydrocarbon waxes, the double bond in the unsaturated waxes is believed to provide a further sacrificial functional group that may provide an additional level of ozone resistance. The additional level of ozone resistance is supplemental to the barrier properties afforded by the unsaturated wax itself. Specifically, ozone may react competitively with the double bond in the unsaturated wax molecules and the double bonds in rubber compounds, thereby potentially extending the time during which the rubber compounds remain suitable for use. Surprisingly, the double bond in the unsaturated waxes does not interrupt the vulcanization (crosslinking) chemistry that occurs when further processing the rubber blends. Further surprisingly, the internal double bond within LAO dimers may be particularly effective in this respect.

The rubber blends disclosed herein may find particular utility in applications where good ozone resistance is needed in combination with robust physical properties. Tire sidewalls are but one example application where rubber blends exhibiting high ozone resistance after vulcanization may be desirable. The ozone resistance conveyed by the unsaturated waxes described herein may be at least comparable to that of conventional saturated hydrocarbon waxes used in tire sidewall applications at similar wax loadings. As a further advantage, the unsaturated waxes disclosed herein may allow the amount of anti-ozonant chemicals incorporated in a rubber blend to be decreased while still maintaining satisfactory ozone resistance in tires and other applications.

All numerical values within the detailed description and the claims herein are modified by “about” or “approximately” with respect to the indicated value, and take into account experimental error and variations that would be expected by a person having ordinary skill in the art.

As used in the present disclosure and claims, the singular article forms “a,” “an,” and “the” include plural forms unless the context clearly dictates otherwise.

The term “and/or” as used in a phrase such as “A and/or B” herein is intended to include “A and B,” “A or B,” “A,” and “B.”

For the purposes of the present disclosure, the new numbering scheme for groups of the Periodic Table is used. In said numbering scheme, the groups (columns) are numbered sequentially from left to right from 1 through 18.

Unless otherwise indicated, room temperature (RT) is about 23° C.

As used herein, the term “hydrocarbon” refers to a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different numbers of carbon atoms. The term “Cₙ” refers to hydrocarbon(s) or a hydrocarbyl group having n carbon atom(s) per molecule or group along the main carbon chain, wherein n is a positive integer. The term “Cₙ₊” refers to hydrocarbon(s) or a hydrocarbon group having n carbon atoms or more per molecule or group along the main carbon chain. The term “Cₙ₋” refers to hydrocarbon(s) or a hydrocarbon group having n carbon atoms or less per molecule or group along the main carbon chain. Such hydrocarbon or hydrocarbyl groups may be one or more of linear, branched, cyclic, acyclic, saturated, unsaturated, aliphatic, or aromatic.

As used herein, the terms “hydrocarbyl” and “hydrocarbyl group” are used interchangeably herein. The term “hydrocarbyl group” refers to any C₁-C₁₀₀ hydrocarbon group bearing at least one unfilled valence position when removed from a parent compound. “Hydrocarbyl groups” may be optionally substituted, in which the term “optionally substituted” refers to replacement of at least one hydrogen atom or at least one carbon atom with a heteroatom or heteroatom functional group. Hydrocarbyl groups therefore may include alkyl, alkenyl, alkynyl, aryl, heteroaryl, cycloalkyl, heterocyclyl, and the like, any of which may be optionally-substituted.

As used herein, the terms “linear” and “linear hydrocarbon” refer to a hydrocarbon or hydrocarbyl group having a continuous carbon chain without side chain branching.

As used herein, the term “olefin,” alternatively referred to as “alkene,” is a linear, branched, or cyclic compound of carbon and hydrogen having at least one carbon-carbon double bond. An olefin is an unsaturated hydrocarbon. As used herein, the term “unsaturated” refers to a hydrocarbon containing at least one carbon-carbon double bond and/or at least one carbon-carbon triple bond.

As used herein, the term “alpha olefin” refers to an olefin having a terminal carbon-carbon double bond in the structure thereof (e.g., RHC═CH₂, where R is hydrogen or a hydrocarbyl group).

As used herein, the term “linear alpha olefin (LAO)” refers to an unbranched alkenic hydrocarbon bearing a carbon-carbon double bond at a terminal (end) carbon atom of a continuous carbon chain without side chain branching.

As used herein, the terms “branch,” “branched,” and “branched hydrocarbon” refer to a hydrocarbon or hydrocarbyl group having a linear continuous carbon chain in which a hydrocarbyl side chain extends from the linear continuous carbon chain.

As used herein, the term “rubber” refers to a natural or synthetic elastomeric compound.

As used herein, the term “blend” refers to a mixture of two or more components. Blends may be produced by, for example, solution blending, melt mixing, or compounding in a shear mixer. The terms “blending,” “combining,” and “compounding” may be used interchangeably herein.

As used herein, the term “copolymer” refers to a polymer containing at least two different monomer units.

Unless otherwise specified, all viscosity values for waxes herein are kinematic viscosities measured by ASTM D-445 at 100° C.

Unless otherwise specified, Mooney viscosity values for rubber blends herein are determined using a Mooney viscometer according to ASTM 1646-19a, except modified as follows. First, a rubber blend is pressed between two hot plates of a compression press prior to testing. The plate temperature is 100° C.+/−0.5° C. Although ASTM D1646-19a allows for several options for die protection, should any two options provide conflicting results, PET 36 micron should be used as the die protection. Further, ASTM D1646-19a does not indicate a sample weight in Section 8; thus, to the extent results may vary based upon sample weight, Mooney viscosity is determined using a sample weight of 21.5+/−2.7 g in the D1646-19a Section 8 procedures. Finally, the rest procedures before testing set forth in D1646-19a Section 8 are 23° C.+/−3° C. for 30 min in air; Mooney values as reported herein were determined after resting at 24° C.+/−3° C. for 30 min in air. Samples are placed on either side of a rotor according to the ASTM D1646-19a test method; torque required to turn the viscometer motor at 2 rpm is measured by a transducer for determining the Mooney viscosity. The results are reported as Mooney Units (ML, 1+4@100° C.), where M is the Mooney viscosity number, L denotes large rotor (defined as ML in ASTM D1646-19a), 1 is the pre-heat time in minutes, 4 is the sample run time in minutes after the motor starts, and 100° C. is the test temperature. Thus, a Mooney viscosity of 90 determined by the aforementioned method would be reported as a Mooney viscosity of 90 MU (ML, 1+4@100° C.). Alternately, the Mooney viscosity may be reported as 90 MU; in such instance, it should be assumed that the just-described method is used to determine such viscosity, unless otherwise noted. In some instances, a lower test temperature may be used (e.g., 90° C.), in which case Mooney is reported as Mooney Viscosity (ML, 1+4@90° C.), or @T° C. where T is the test temperature.

Unless otherwise specified, Mooney Scorch values are determined using a moving die rheometer. In the scorch test, viscosity decreases before increasing as vulcanization progresses. The test measures the time (scorch time) needed for viscosity to increase from a minimum viscosity value (Vm) to a specified increased value (scorch point). The specified increase herein was a 5 Mooney unit increase.

Unless otherwise specified, tc90 values represent the time at which 90% curing of a rubber blend has taken place, determined using a moving die rheometer.

Unless otherwise specified, tensile strength testing values are determined according to ASTM D412-16 using Die C at a test speed of 500 mm/min.

Unless otherwise specified, Shore hardness is measured according to ASTM D2240-15e1 (Reapproved 2021), with a 3-second delay using a Shore A scale.

Unless otherwise specified, tear strength is measured according to ASTM D624-00 (2020).

Unless otherwise specified, fatigue to failure testing (FTFT) is measured according to ASTM D4482-11(2021).

Unless otherwise specified, peel adhesion strength represents the force required to separate vulcanized layers of a rubber blend by means of a tension machine (this is also known as 180° Peel). Peel adhesion testing is based on ASTM D413-98(2017) where the test specimen width is one inch, the testing speed is 5 inch/minute, and the test is performed at room temperature.

Unless otherwise specified, abrasion testing measures abrasion resistance in terms of volume loss in cubic millimeters or abrasion resistance index (ARI) in percent of rubber when moving a test piece across the surface of an abrasive sheet mounted to a revolving drum. Abrasion testing is based on ASTM D5963-04(2019).

Unless otherwise specified, crack initiation is measured by DeMattia Crack Initiation testing. The DeMattia Crack Initiation testing method determines crack initiation resistance by repeated bending motions between the stationary and mobile grips of a DeMattia flexing machine. DeMattia Crack Initiation testing is performed based on ASTM D430-06(2018).

Unless otherwise specified, crack growth is measured by DeMattia Crack Growth testing. The DeMattia Crack Growth testing method determines crack growth resistance by repeated bending motions between the stationary and mobile grips of a DeMattia flexing machine. DeMattia Crack Growth testing is performed based on ASTM D813-07(2019).

Accordingly, rubber blends of the present disclosure may comprise at least one rubber compound, and at least one wax mixed with the at least one rubber compound, in which the at least one wax comprises an unsaturated wax. Additional description of suitable rubber compounds and unsaturated waxes is provided hereinbelow. Other components commonly incorporated in rubber blends may also be suitably present in combination with the unsaturated waxes and are also specified in more detail hereinbelow. Depending on whether the rubber blends are deployed in their end-use application and the nature of the end-use application, the rubber blends may be optionally vulcanized.

Rubber blends of the present disclosure may be prepared by any suitable mixing process. Mixing may be performed by dry blending, melt blending, or a combination thereof, such as by a masterbatch mixing technique. Mixing may also be performed by blending components using conventional masticating equipment such as, for example, a rubber mill, a Brabender Mixer, a Banbury Mixer, a Buss-Ko Kneader, a Farrel continuous mixer or twin-screw continuous mixer until a homogeneous blend is obtained. Mixing of the various components of the rubber blends may be performed in any order. Mixing temperatures may depend on the particular rubber blend being formed, with about 150° C. to about 160° C. commonly being a suitable range. Other embodiments may employ mixing temperatures of about 130° C. to about 160° C., or about 130° C. to about 200° C., or about 150° C. to about 170° C., or about 150° C. to about 200° C.

Suitable unsaturated waxes for rubber blends in the disclosure herein may include LAOs within a specified size (molecular weight) range or LAO dimers prepared from the LAOs, which contain an internal olefin. Suitable unsaturated waxes may include, but are not limited to, (a) one or more C₁₈₊ linear alpha olefins (LAOs), such as LAOs having a kinematic viscosity (ASTM D-445) of about 4 cSt or less at 100° C.; or (b) one or more LAO dimers formed from one or more C₁₈₊ LAOs, and the one or more LAO dimers having an internal olefin and a kinematic viscosity (ASTM D-445) of about 6 cSt or less at 100° C.

In non-limiting examples, suitable LAOs may comprise C₂₀-C₂₄ LAOs or C₂₄₊ LAOs. Thus, in some embodiments, at least a majority of the one or more C₁₈₊ LAOs may comprise C₂₀-C₂₄ LAOs or C₂₄₊ LAOs. Suitable LAO dimers having an internal olefin may comprise dimers of C₂₀-C₂₄ LAOs or dimers of C₂₄₊ LAOs, preferably dimers of C₂₀-C₂₄ LAOs. The LAO dimers may have 2 carbon atoms less than the LAOs from which they were produced. Thus, LAO dimers formed from C₂₀-C₂₄ LAOs may contain 38 to 46 carbon atoms, and LAO dimers formed from C₂₄₊ LAOs may contain 46 carbon atoms or more. Preferred LAO dimers for forming the rubber blends described herein may comprise one or more LAO dimers formed from C₂₀-C₂₄ LAOs and containing an internal olefin, in which the one or more LAO dimers have a kinematic viscosity of about 6.5 cSt or less at 100° C. (ASTM D-445).

Processes suitable for forming LAOs for use in the disclosure herein are not believed to be particularly limited. LAOs within the foregoing size ranges may be synthesized by several different processes starting from low molecular weight feedstock materials. A primary route for synthesizing LAOs is via ethylene oligomerization, of which there are several synthetic variants that may be mediated using different Ziegler-type catalysts. LAOs may also be produced by fatty alcohol dehydration and renewable/biomass-derived processes (e.g., processes employing lactones, unsaturated fatty acids, ethanol, or the like), or any combination of these. Depending on the particular Ziegler-type catalyst and the synthetic conditions, ethylene oligomerization reactions may form a range of homologous LAOs having an even number of carbon atoms (i.e., C₂ₙH₂ₙ, where n is a positive integer greater than or equal to 2), or a predominant LAO (e.g., 1-butene, 1-hexene, 1-octene, or 1-decene) may be produced. When multiple LAOs are formed, the product distribution of the LAOs may follow a Schulz-Flory distribution, with the distribution being arranged about a central molecular weight. Such processes are commonly referred to as full-range or wide-range LAO synthesis processes. LAO syntheses affording a predominant LAO (e.g., about 70% or more or even about 90% or more of the LAOs in the product stream) may also form up to about 10 wt % of other minor product LAOs and additional byproducts. Such LAO syntheses are referred to herein as being “specific” LAO syntheses, and they may sometimes be referred to in the art as “on-purpose” LAO syntheses.

Fractional distillation processes are frequently employed to separate LAO product streams into desired fractions comprising individual or multiple LAOs. Typical distillation processes for separating LAOs from one another may employ a two-product distillation column to isolate an overhead stream comprising an individual LAO or LAO mixture and a bottoms stream comprising a mixture of LAOs having higher boiling points than those obtained in the overhead stream. This process may be iterated until LAOs up to a desired carbon count have been separated from one another. For example, in the case of the present disclosure, C₁₈-C₂₄ or C₂₀-C₂₄ LAOs may be obtained as an overhead stream during distillation and C₂₄₊ LAOs may be obtained separately as a bottoms stream. The LAOs in each fraction may have an even carbon count (i.e., contain C₂ₙ carbon atoms, wherein n is an integer greater than or equal to 2). Preferably, suitable C₁₈₊ LAOs may comprise predominantly C₁₈-C₂₄ LAOs, C₂₀-C₂₄ LAOs, or C₂₄₊ LAOs, or any of their dimerized forms containing an internal olefin.

Dimerization of LAOs may occur through a metathesis process in the presence of a suitable metal carbene catalyst, resulting in loss of ethylene and formation of a linear olefin dimer having an internal double bond. Dimerization may take place in a continuous mode, such as in a continuous stirred tank reactor or a tubular reactor.

C₂₀-C₂₄ LAOs may have a kinematic viscosity (ASTM D-445) of about 5 cSt or less or about 4 cSt or less at 100° C., such as about 1 cSt to about 4 cSt at 100° C., or about 1.5 cSt to about 3.5 cSt at 100° C., or about 2 cSt to about 3 cSt at 100° C., or about 1 cSt to about 2 cSt at 100° C., or about 1 cSt to about 1.5 cSt at 100° C.; a congealing point (ASTM D-938) ranging from about 5° C. to about 150° C., or from about 10° C. to about 140° C., or from about 15° C. to about 130° C., or from about 20° C. to about 120° C., or from about 25° C. to about 110° C., or from about 30° C. to about 100° C.; and a melting point (ASTM D-87) ranging from about 5° C. to about 200° C., or from about 10° C. to about 175° C., or from about 15° C. to about 150° C., or from about 20° C. to about 125° C., or from about 25° C. to about 100° C.

A sample containing C₂₀-C₂₄ LAOs may have an alpha olefin content ranging from about 50 mol. % to about 100 mol. %, or about 55 mol. % to about 95 mol. %, or about 60 mol. % to about 90 mol. %, or about 65 mol. % to about 85 mol. %, or about 70 mol. % to about 80 mol. %; a vinylidene olefin content ranging from about 1 mol. % to about 30 mol. %, or about 2 mol. % to about 20 mol. %, or about 3 mol. % to about 10 mol. %; and an internal olefin content of about 10 mol. % or less, such as an internal olefin content ranging from 0 mol. % to about 10 mol. %, or 0 mol. % to about 4 mol. %.

C₂₄₊ LAOs may have a kinematic viscosity (ASTM D-445) of about 4 cSt or less or about 5 cSt or less at 100° C., such as about 1 cSt to about 4 cSt at 100° C., or about 1.5 cSt to about 3.5 cSt at 100° C., or about 2 cSt to about 3 cSt at 100° C., or about 1 cSt to about 2 cSt at 100° C., or about 1 cSt to about 1.5 cSt at 100° C.; a congealing point (ASTM D-938) ranging from about 5° C. to about 150° C., or from about 10° C. to about 140° C., or from about 15° C. to about 130° C., or from about 20° C. to about 120° C., or from about 25° C. to about 110° C., or from about 30° C. to about 100° C.; and a melting point (ASTM D-87) ranging from about 5° C. to about 200° C., or from about 10° C. to about 175° C., or from about 15° C. to about 150° C., or from about 20° C. to about 125° C., or from about 25° C. to about 100° C.

A sample containing C₂₄₊ LAOs may have an alpha olefin content ranging from about 50 mol. % to about 100 mol. %, or about 55 mol. % to about 95 mol. %, or about 60 mol. % to about 90 mol. %, or about 65 mol. % to about 85 mol. %, or about 70 mol. % to about 80 mol. %; a vinylidene olefin content ranging from about 1 mol. % to about 30 mol. %, or about 2 mol. % to about 20 mol. %, or about 3 mol. % to about 10 mol. %; and an internal olefin content of about 10 mol. % or less, such as an internal olefin content ranging from 0 mol. % to about 10 mol. %, or 0 mol. % to about 4 mol. %.

Any of the C₁₈₊ LAOs described above may be dimerized to form LAO dimers having an internal olefin, which may also be suitably incorporated as an unsaturated wax in the rubber blends described herein. Preferably, LAO dimers formed from C₂₀-C₂₄ LAOs may be utilized in the rubber blends described herein. Suitable LAO dimers comprising an internal olefin (e.g., C₃₄-C₄₆ LAO dimers, C₃₆-C₄₆ LAO dimers, or C₄₆₊ LAO dimers) may have a kinematic viscosity (ASTM D-445) of about 6.5 cSt or less at 100° C., such as about 3.5 cSt to about 5.5 cSt or about 4 cSt to about 5.5 cSt at 100° C.

In some embodiments, the rubber blends of the present disclosure may further comprise a paraffinic hydrocarbon oil, a paraffinic hydrocarbon wax, a microcrystalline wax, or any combination thereof in further combination with the at least one unsaturated wax. A suitable ratio of unsaturated wax to paraffinic hydrocarbon oil, paraffinic hydrocarbon wax, or microcrystalline wax may range from about 9:1 to about 1:9 on a mass basis. Preferably, the unsaturated wax may comprises at least a majority of the at least one wax by mass (e.g., at least 50 wt. % or above on a weight basis).

Illustrative paraffinic hydrocarbon waxes that may be present in combination with the unsaturated waxes disclosed herein include, but are not limited to, PARVAN™ 1580 (ExxonMobil), VARAZON 5998 (Hywax), and IGI 1297A (International Group). Illustrative paraffinic hydrocarbon waxes that are Fischer-Tropsch waxes and may be present in combination with the unsaturated waxes include those produced by conversion of natural gas or gasification of coal under known conditions to produce synthesis gas (CO+H₂). Common Fischer-Tropsch waxes may have a melting point of about 75° C. or greater and/or feature a carbon count of about C₁₉₊ or higher, wherein there is a continuous distribution of carbon chain sizes. Illustrative Fischer-Tropsch waxes that may be present in combination with the unsaturated waxes include, but are not limited to, high-melting Fischer-Tropsch waxes such as SASOLWAX C80 and SASOLWAX™ H1 (available from Sasol). Functionalized Fischer-Tropsch waxes may be suitable in some instances.

In the rubber blends of the present disclosure, the at least one wax may be present in the rubber blends in various amounts. In various embodiments, the at least one wax may be present in the rubber blends disclosed herein in an amount ranging from about 0.25 wt % to about 10 wt %, or about 0.5 wt % to about 5 wt %, or about 0.5 wt % to about 2.5 wt %, each based upon total mass of the rubber blend. The foregoing broadly correspond to wax amounts ranging from about 0.1 phr to about 10 phr (parts per 100 parts rubber). If only unsaturated waxes are present, the foregoing values represent the weight percentages (or phr values) of unsaturated wax present in the rubber blends.

The types of rubber compounds present in the rubber blends disclosed herein are not believed to be particularly limited. In non-limiting examples, the at least one rubber compound may comprise natural rubber, synthetic polyisoprene, butadiene rubber, butyl rubber, bromobutyl rubber, chlorobutyl rubber, ethylene-propylene-diene monomer (EPDM) rubber, a brominated copolymer of isobutylene and p-methylstyrene, or any combination thereof.

As used herein, the term “natural rubber” refers to naturally occurring rubber harvested from sources such as Hevea rubber trees and non-Hevea sources (e.g., guayule shrubs and dandelions). Natural rubber comprises predominantly cis-polyisoprene. As used herein, the term “synthetic polyisoprene” refers to a polymer that is manufactured from isoprene monomers and comprises predominantly cis-polyisoprene. In other words, natural rubber is distinguished from synthetic polyisoprene based at least upon its origin.

In some specific examples, the at least one rubber compound may comprise a mixture of natural rubber and butadiene rubber. When so used, the ratio of natural rubber to butadiene rubber may range from about 1:99 to 99:1 on a mass basis, or about 1:9 to about 9:1, or about 3:7 to about 7:3, or about 4:6 to about 6:4. In some embodiments, approximately equivalent amounts of natural rubber and butadiene rubber may be present. Optionally, synthetic polyisoprene may replace at least a portion of the natural rubber in any of the foregoing.

As used herein, the term “butadiene rubber (BR)” refers to a homopolymer or copolymer of 1,4-butadiene. Butadiene rubbers that may suitably comprise the at least one rubber compound include, for example, styrene-butadiene rubbers (SBR), styrene-butadiene-isoprene rubbers, isoprene-butadiene rubbers, and the like.

Suitable examples of BR may include a high cis-polybutadiene (“cis-BR”). “Cis-polybutadiene” or “high cis-polybutadiene” refers to a BR where 1,4-cis polybutadiene is used to produce the cis-BR and the cis component in the cis-BR is at least 95%. An example of a commercially available BR is DIENE™ 140ND (a high cis BR, available from Firestone Polymers).

Alternately, the BR may be a low cis-polybutadiene like those made with Li catalysts. The BR may also include a variety of functional groups (including but not excluded to silanes, epoxides, amines, amides or combinations of these functional groups) on one or both chain ends, on the polymer backbone, or both on the polymer backbone and chain ends.

The SBR may be an emulsion-SBR (E-SBR), a solution SBR (S-SBR), a high styrene rubber (HSR), and the like. The SBR may have a styrene content from 10 wt % to 60 wt %, or 10 wt % to 50 wt %, or 15 wt % to 30 wt %. The SBR may have a vinyl content from 5 wt % to 60 wt %, or 5 wt % to 40 wt %, or 20 wt % to 50 wt %. The SBR may also include a variety of functional groups (including but not excluded to silanes, epoxides, amines, amides or combinations of these functional groups) on one or both chain ends, on the polymer backbone, or both on the polymer backbone and chain ends. Examples of commercially available SBRs include, but are not limited to, NIPOL® (a SBR, available from Zeon Corp.) and SBR elastomers available from JSR Corporation, which include JSR 1500 (25 wt % styrene), JSR 1502 (25 wt % styrene), JSR 1503 (25 wt % styrene), JSR 1507 (25 wt % styrene), JSR 0202 (45 wt % styrene), JSR SL552 (25 wt % styrene), JSR SL574 (15 wt % styrene), JSR SL563 (20 wt % styrene), JSR 0051, JSR 0061, or the like.

Suitable SBRs may have a Mooney viscosity at 100° C. (ML 1+4, ASTM D1646-19a) of 30 to 120 Mooney units or 40 to 80 Mooney units.

As used herein, the term “butyl rubber” refers to a copolymer of one or more C₄-C₇ isoolefins, preferably isobutylene, and a conjugated diene, preferably isoprene. Illustrative examples of the isoolefins which may be used in the preparation of butyl rubber are isobutylene, 2-methyl-1-propene, 3-methyl-1-butene, 4-methyl-1-pentene and beta-pinene. Illustrative examples of conjugated dienes which may be used in the preparation of butyl rubber include, for example, isoprene, butadiene, 2,3-dimethylbutadiene, piperylene, 2,5-dimethylhexa-2,4-diene, cyclopentadiene, cyclohexadiene and methylcyclopentadiene. Suitable butyl rubbers may contain about 85 mol % to about 99.5 mol %, or about 90 mol % to about 99.5 mol % or about 95 mol % to about 99.5 mol % of C₄-C₇ isoolefins and about 0.5 mol % to about 15 mol %, or about 0.5 to about 10 mol %, or about 0.5 mol % to about 5 mol % of conjugated diene.

The term “butyl rubber” also encompasses functionalized butyl rubber compounds, such as chlorobutyl rubber or bromobutyl rubber.

Suitable ethylene-propylene-diene monomer rubbers are terpolymers prepared by polymerizing (i) propylene with (ii) at least one of ethylene and C₄-C₂₀ α-olefins and (iii) one or more diene monomers. In an embodiment, the ethylene-propylene-diene monomer rubber may be halogenated. In another embodiment, the ethylene-propylene-diene monomer rubber may have an amorphous morphology.

The comonomers in ethylene-propylene-diene monomer (EPDM) rubbers may be linear or branched. Suitable linear comonomers may include ethylene or C₄-C₈ α-olefins such as ethylene, 1-butene, 1-hexene, and 1-octene, even more preferably ethylene or 1-butene. Suitable branched comonomers that may optionally be present include 4-methyl-1-pentene, 3-methyl-1-pentene, and 3,5,5-trimethyl-1-hexene. Suitable co-monomers may also be aromatic, such as styrene.

The dienes in EPDM rubbers may be conjugated or non-conjugated. Preferably, suitable dienes are non-conjugated. Illustrative dienes that may be present in EPDM rubbers include, but are not limited to, 5-ethylidene-2-norbornene (ENB), 1,4-hexadiene, 5-methylene-2-norbornene (MNB), 1,6-octadiene, 5-methyl-1,4-hexadiene, 3,7-dimethyl-1,6-octadiene, 1,3-cyclopentadiene, 1,4-cyclohexadiene, vinyl norbornene (VNB), dicyclopentadiene (DCPD); or any combinations thereof. Preferably, the diene is ENB or VNB. Preferably, the EPDM rubber has a diene monomer content of about 0.5 wt % to about 8 wt %, or about 2 wt % to about 6 wt %, or about 3 wt % to about 5 wt %, each based upon mass of the copolymer.

Suitable EPDM rubbers may have a propylene content of about 50 wt %, such as about 65 wt % to about 95 wt %, or about 70 wt % to about 95 wt %, or about 75 wt % to about 95 wt %, or about 80 wt % to 95 wt %, or about 83 wt % to about 95 wt %, or about 84 wt % to about 95 wt %, or about 84 wt % to about 94 wt %, or about 72 wt % to about 95 wt %, or about 80 wt % to about 93 wt %, or about 85 wt % to about 89 wt %, based on the weight of the polymer. The balance of the EPDM rubber may comprise at least one of ethylene and C₄-C₂₀ α-olefin and one or more dienes. The α-olefin may be ethylene, butene, hexane, or octane, for example. Preferred ranges for the amount of ethylene and/or one or more α-olefins include from about 2 wt % to about 15 wt %, or about 5 wt % to about 15 wt %, or about 8 wt % to about 15 wt %, or about 8 to about 12 wt %, based on the weight of the polymer. Preferred ranges for the diene content may range from about 1 wt % to about 16 wt %, or about 1 wt % to about 12 wt %, or about 2 wt % to about 6 wt %, or about 2 wt % to about 6 wt %.

Suitable EPDM rubbers may have a melt flow rate (MFR, 2.16 kg weight at 230° C.), equal to or greater than 0.1 g/10 min as measured according to the ASTM D-1238-13. Preferably, the MFR (2.16 kg at 230° C.) is about 0.5 g/10 min to about 200 g/10 min, or about 0.5 g/10 min to about 100 g/10 min, or about 0.5 g/10 min to about 30 g/10 min, or about 0.5 g/10 min to about 10 g/10 min, or about 0.5 g/10 min to about 5 g/10 min, or about 0.5 g/10 min to about 2 g/10 min, or about 0.1 g/10 min to about 15 g/10 min.

Suitable copolymers of isobutylene and p-methylstyrene may be prepared as described in U.S. Pat. No. 5,162,445. The copolymer may then be brominated upon at least a portion of the p-methyl substituents to obtain a brominated copolymer of isobutylene and p-methylstyrene that may be suitably used as at least one rubber compound in the disclosure herein. Bromination may take place as described in the foregoing U.S. patent, for example. Suitable brominated copolymers of isobutylene and p-methylstyrene are sold under the EXXPRO™ label by ExxonMobil Chemical.

The rubber blends may further comprise one or more inorganic fillers. The term “filler” as used herein refers to any material that is used to reinforce or modify physical properties, impart certain processing properties, or reduce cost of a rubber blend. Examples of fillers may include, but are not limited to, calcium carbonate, clay, mica, silica, silicates, talc, titanium dioxide, alumina, zinc oxide, starch, wood flour, carbon black, or mixtures thereof. The fillers may be any size range used, for example, in the tire industry, such as from about 0.0001 μm to about 100 μm in size.

The rubber blends may comprise carbon black. All carbon blacks, in particular carbon blacks of the HAF, ISAF or SAF type, conventionally used in tires (“tire-grade” blacks) are suitable as carbon blacks for use in the disclosure herein. Reinforcing carbon blacks of the 100, 200 or 300 series (ASTM grades), such as, for example, the N115, N134, N234, N326, N330, N339, N347 or N375 blacks, or also, depending on the applications targeted, the carbon blacks of higher series (for example, N660, N683 or N772) may be used.

In various embodiments, the rubber blends may comprise carbon black in an amount ranging from about 20 wt % to about 50 wt %, or about 25 wt % to about 45 wt %, based on total mass of the rubber blend.

The rubber blends may comprise silica. As used herein, the term “silica” refers to any type or particle size of silica (SiO₂) or another silicic acid derivative, or silicic acid, processed by solution, pyrogenic, or like methods, including untreated, precipitated silica, crystalline silica, colloidal silica, aluminum or calcium silicates, fumed silica, and the like. Precipitated silica can include conventional silica, semi-highly dispersible silica, or highly dispersible silica.

In various embodiments, the rubber blends may comprise silica in an amount ranging from about 20 wt % to about 50 wt %, or about 25 wt % to about 45 wt %, based on total mass of the rubber blend.

Other illustrative inorganic fillers that may be present in the rubber blends include, for example, aluminum oxide, metal hydroxides, titanium oxides, silicon carbides, or any combination thereof. Such additional inorganic fillers may be present in an amount greater than, less than, or equal to an amount of silica used.

To promote vulcanization, the rubber blends may comprise at least one curative package, at least one curative, and/or at least one vulcanizing or crosslinking agent. As used herein, at least one curative package refers to any material capable of imparting cured properties to a rubber as is commonly understood in the rubber industry. Suitable crosslinking agents may include sulfur, sulfur halides, organic peroxides, quinone dioximes, organic polyvalent amine compounds, methylol group-containing alkylphenol resins, the like, or any combination thereof.

A preferred crosslinking agent is sulfur. The sulfur may be provided either as free sulfur, within a sulfur donor, or combinations thereof. Suitable free sulfur sources include, for example, pulverized sulfur, rubber maker's sulfur, commercial sulfur, and insoluble sulfur. Suitable sulfur donors may include amine disulfides, tetramethyl thiuram disulfide (Akrochem TMTD), 4,4′-dithiodimorpholine (Akrochem DTDM), dipentamethylene thiuram tetrasulfide (Akrochem DPTT) and thiocarbamyl sulfonamide (Akrochem Cure-Rite 18). The amount of sulfur within the rubber blends may range from about 0.1 wt % to about 5 wt %, or about 0.5 wt % to about 2.5 wt %, or about 0.5 wt % to about 1.5 wt % based on total mass of the rubber blend.

Suitable curative packages may also contain various chemicals, additives, and the like which are commonly used in the rubber industry, as desired. Examples of such chemicals or additives include vulcanizing aids, processing aids, vulcanizing accelerators, vulcanizing retarders, process oils, anti-aging agents, anti-scorching agents, zinc oxide, stearic acid, and the like. In one embodiment, one or more components may be included in a naphthenic oil, for example.

Vulcanizing accelerators help control the onset of and rate of vulcanization, and the number and type of crosslinks that are formed. Vulcanizing retarders may be used to delay the initial onset of cure in order to allow sufficient time to process the unvulcanized rubber.

Examples of vulcanizing accelerators include, for example, sulfenamide-based, guanidine-based, thiuram-based, thiourea-based, benzothiazole-based, dithiocarbamic acid-based, and xanthogenic acid-based compounds, and preferably include 2-mercaptobenzothiazole, dibenzothiazyl disulfide, N-cyclohexyl-2-benzothiazylsulfenamide, N-t-butyl-2-benzothiazolesulfenamide, N-oxyethylene-2-benzothiazolesulfenamide, N-oxyethylene-2-benzothiazolesulfenamide, N,N′-diisopropyl-2-benzothiazolesulfenamide, diphenylguanidine, diorthotolylguanidine, orthotolylbisguanidine, and the like.

Examples of guanidine-based vulcanizing accelerators include diphenylguanidine (DPG), diorthotolylguanidine (DOTG) and orthotolylbisguanidine.

Examples of dithiocarbamic acid-based vulcanizing accelerators include tetramethylthiuram monosulfide (TMTM), tetramethylthiuram disulfide (TMTD) and zinc diethylthiocarbamate (ZDEC). Examples of sulfenamide-based vulcanizing accelerators include N-cyclohexyl-2-benzothiazylsulfenamide (CBS), N-t-butyl-2-benzothiazolesulfenamide (TBBS), N-oxyethylene-2-benzothiazolesulfenamide, N-oxyethylene-2-benzothiazolesulfenamide, N,N′-diisopropyl-2-benzothiazolesulfenamide, 2-morpholinothiobenzothiazole (MBS) and N-dicyclohexylbenzothiazole-2-sulfenamide (DCBS). Examples of benzothiazole-based vulcanizing accelerators include 2-mercaptobenzothiazole (MBT), dibenzothiazyl disulfide and 2,2′-dithiobisbenzothiazole (MBTS).

Processing aids include isoparaffins, polyalphaolefins (“PAOs”) and polybutenes (a subgroup of PAOs). These three classes of compounds can be described as paraffins, which can include branched, cyclic, and normal structures, and blends thereof. Suitable processing aids may include C₆ to C₂₀₀ paraffins or C₈ to C₁₀₀ paraffins in another embodiment. Examples of commercially available paraffinic processing aids include, but are not limited to, NYTEX® 4700 (naphthenic processing oil, available from Nynas), NOCHEK® 4756A (paraffin wax blend, available from Sovereign Chemicals), and the like.

Other suitable processing aids may include esters, polyethers, and polyalkylene glycols. Other processing aids may include, but are not limited to, plasticizers, tackifiers, extenders, chemical conditioners, homogenizing agents and peptizers such as mercaptans, petroleum and vulcanized vegetable oils, mineral oils, paraffinic oils, polybutene aids, naphthenic oils, aromatic oils, waxes, resins, rosins, and the like.

The rubber blends described herein may comprise a tackifier, also referred to as a tackifier resin component, comprising one or more hydrocarbon tackifier resins, as described further herein. Tackifier resin components may include amorphous, low molecular weight natural or synthetic hydrocarbon resin materials that modify the adhesive characteristics. Natural resins may include resins of plant or animal origin which include but are not limited to rosins such as gum, wood, or tall oil rosins. Synthetic resins may include resins resulting from controlled chemical reactions, such as hydrocarbon resins produced from such reactions. Examples of synthetic hydrocarbon resins may include coal tar resins, petroleum resins, and turpentine resins.

In addition to the ozone protection conveyed by the at least one wax within the rubber blends, the rubber blends may further comprise at least one anti-ozonant compound to provide an additional type of protection against ozone. Suitable anti-ozonant compounds may include phenylenediamines such as N,N′-substituted p-phenylenediamines. Illustrative N,N′-substituted p-phenylenediamines commonly used as anti-ozonant chemicals may include, for example, N-(1,3-dimethylbutyl)-N′-phenyl-p-phenylenediamine (6PPD), N-isopropyl-N′-phenyl-p-phenylenediamine (IPPD), N,N′-diphenyl-p-phenylenediamine (DPPD), 6-ethoxy-2,2,4-trimethyl-1,2-dihydroquinoline, and the like. Other classes of anti-ozonant chemicals that may be used include, for example, metal dithiocarbamates and substituted thioureas. When used, anti-ozonant compounds may be present at about 5 wt % or below, or about 4 wt % or below, or about 3 wt % or below, or about 2 wt % or below, or about 1 wt % or below based on total mass of the total rubber blend.

The rubber blends disclosed herein may comprise at least a portion of a rubber article. Illustrative rubber articles may include, but are not limited to, hoses, belts (e.g. conveyer belts), tubes, flaps, o-rings, gaskets, tires, the like, or any portion thereof. Depending upon the type of article being formed from the rubber blends and the anticipated use conditions thereof, the rubber blend may be vulcanized or un-vulcanized.

The rubber blends may be vulcanized (cured) by any suitable means, such as subjecting them to heat or radiation according to any conventional vulcanization process. The amount of heat or radiation needed is that required to affect a desired extent of curing. In non-limiting examples, vulcanization may be conducted at a temperature ranging from 100° C. to about 250° C. or about 150° C. to about 200° C. over a period of time ranging from about 1 minute to about 150 minutes.

In more particular examples, the rubber blends disclosed herein may comprise at least a portion of a tire, more specifically at least a portion of a sidewall of a tire. The FIGURE is a diagram of a portion of an illustrative tire. As shown, tire 100 includes tire sidewall 102, first belt 104, second belt 106, tread 108, bead 110, innerliner 112, first body ply 114, and second body ply 116. A tire innertube (not illustrated) is an inflatable tube containing air that is placed in between a metal rim and innerliner 112 for tube-type tires. Thus, tires comprising a rubber blend of the present disclosure may comprise a sidewall formed from a rubber blend that is vulcanized and comprises at least one rubber compound, and at least one wax mixed with the at least one rubber compound, in which the at least one wax comprises an unsaturated wax. Any of die rubber blends described herein may be utilized in forming a tire sidewall to convey enhanced ozone resistance thereto.

Embodiments disclosed herein include:

A. Rubber blends. The rubber blends comprise: at least one rubber compound; and at least one wax mixed with the at least one rubber compound; wherein the at least one wax comprises an unsaturated wax.

A1. Rubber articles comprising the rubber blend of A, optionally wherein the rubber article is selected from the group consisting of a hose, a belt, a tube, a flap, an O-ring, a tire, and a gasket.

B. Tires having a modified sidewall. The tire comprise: a sidewall formed from a rubber blend that is vulcanized and comprises: at least one rubber compound; and at least one wax mixed with the at least one rubber compound; wherein the at least one wax comprises an unsaturated wax.

Embodiments A, A1, and B may have one or more of the following additional elements in any combination:

Element 1: wherein the at least one rubber compound comprises natural rubber, synthetic polyisoprene, butadiene rubber, butyl rubber, bromobutyl rubber, chlorobutyl rubber, ethylene-propylene-diene monomer rubber, a brominated copolymer of isobutylene and p-methylstyrene, or any combination thereof.

Element 2: wherein the at least one rubber compound comprises a mixture of natural rubber and butadiene rubber.

Element 3: wherein the unsaturated wax comprises one or more of C₁₈₊ linear alpha olefins (LAOs); LAO dimers formed from Cis'₀ LAOs, the LAO dimers having an internal olefin; or any combination thereof.

Element 4: wherein the unsaturated wax comprises one or more C₁₈₊ LAOs, and the one or more C₁₈₊ LAOs have a kinematic viscosity (ASTM D-445) of about 4 cSt or less at 100° C.

Element 5: wherein at least a majority of the one or more C₁₈₊ LAOs comprise C₂₀-C₂₄ LAOs, or C₂₄₊ LAOs.

Element 6: wherein the unsaturated wax comprises one or more LAO dimers formed from C₂₀-C₂₄ LAOs, the one or more LAO dimers having an internal olefin, and the one or more LAO dimers having a kinematic viscosity (ASTM D-445) of about 6.5 cSt or less at 100° C.

Element 7: wherein the rubber blend further comprises at least one anti-ozonant compound.

Element 8: wherein the rubber blend further comprises a paraffinic hydrocarbon wax, a microcrystalline wax, or any combination thereof.

Element 9: wherein the unsaturated wax comprises at least a majority of the at least one wax by mass.

By way of non-limiting example, illustrative combinations applicable to one or more of A, A1, an B may include, but are not limited to, 1 or 2, and 3; 1 or 2, and 4; 1 or 2, and 4 and 5; 1 or 2, and 3 and 5; 1 or 2, and 6; 1 or 2, and 5 and 6; 1 or 2, and 7; 1 or 2, and 8; 1 or 2, and 7 and 8; 1 or 2, and 9; 1 or 2, and 7-9; 1 or 2, and 3 and 9; 1 or 2, and 4 and 9; 1 or 2, and 6 and 9; 3, 4, or 6, and 7; 3, 4, or 6, and 8; 3, 4, or 6, and 7 and 8; 3, 4, or 6, and 9; 3, 4, or 6, and 7-9; 3, 4, or 6, and 7 and 9; 3, 4, or 6, and 8 and 9; 7 and 8; 7 and 9; 7-9; and 8 and 9.

The present disclosure is also directed to the following non-limiting embodiments:

Embodiment 1. A rubber blend comprising:
at least one rubber compound; and
at least one wax mixed with the at least one rubber compound;
   wherein the at least one wax comprises an unsaturated wax.

Embodiment 2. The rubber blend of Embodiment 1, wherein the at least one rubber compound comprises natural rubber, synthetic polyisoprene, butadiene rubber, butyl rubber, bromobutyl rubber, chlorobutyl rubber, ethylene-propylene-diene monomer rubber, a brominated copolymer of isobutylene and p-methylstyrene, or any combination thereof.

Embodiment 3. The rubber blend of Embodiment 1, wherein the at least one rubber compound comprises a mixture of natural rubber and butadiene rubber.

Embodiment 4. The rubber blend of any one of Embodiments 1-3, wherein the unsaturated wax comprises one or more of C₁₈₊ linear alpha olefins (LAOs); LAO dimers formed from C₁₈₊ LAOs, the LAO dimers having an internal olefin; or any combination thereof.

Embodiment 5. The rubber blend of any one of Embodiments 1-3, wherein the unsaturated wax comprises one or more C₁₈₊ LAOs, and the one or more C₁₈₊ LAOs have a kinematic viscosity (ASTM D-445) of about 4 cSt or less at 100° C.

Embodiment 6. The rubber blend of Embodiment 4 or Embodiment 5, wherein at least a majority of the one or more C₁₈₊ LAOs comprise C₂₀-C₂₄ LAOs, or C₂₄₊ LAOs.

Embodiment 7. The rubber blend of any one of Embodiments 1-3, wherein the unsaturated wax comprises one or more LAO dimers formed from C₂₀-C₂₄ LAOs, the one or more LAO dimers having an internal olefin, and the one or more LAO dimers having a kinematic viscosity (ASTM D-445) of about 6.5 cSt or less at 100° C.

Embodiment 8. The rubber blend of any one of Embodiments 1-7, further comprising:
at least one anti-ozonant compound.

Embodiment 9. The rubber blend of any one of Embodiments 1-8, further comprising:
a paraffinic hydrocarbon wax, a microcrystalline wax, or any combination thereof.

Embodiment 10. The rubber blend of Embodiment 9, wherein the unsaturated wax comprises at least a majority of the at least one wax by mass.

Embodiment 11. A rubber article comprising the rubber blend of any one of Embodiments 1-10.

Embodiment 12. The rubber article of Embodiment 11, wherein the rubber article is selected from the group consisting of a hose, a belt, a tube, a flap, an O-ring, a tire, and a gasket.

Embodiment 13. A tire comprising:
a sidewall formed from a rubber blend that is vulcanized and comprises:
   at least one rubber compound; and
   at least one wax mixed with the at least one rubber compound;
      wherein the at least one wax comprises an unsaturated wax.

Embodiment 14. The tire of Embodiment 13, wherein the at least one rubber compound comprises natural rubber, synthetic polyisoprene, butadiene rubber, butyl rubber, bromobutyl rubber, chlorobutyl rubber, ethylene-propylene-diene monomer rubber, a brominated copolymer of isobutylene and p-methylstyrene, or any combination thereof.

Embodiment 15. The tire of Embodiment 13, wherein the at least one rubber compound comprises a mixture of natural rubber and butadiene rubber.

Embodiment 16. The tire of any one of Embodiments 13-15, wherein the unsaturated wax comprises one or more of C₁₈₊ linear alpha olefins (LAOs); LAO dimers formed from C₁₈₊ LAOs, the LAO dimers having an internal olefin; or any combination thereof.

Embodiment 17. The tire of any one of Embodiments 13-15, wherein the unsaturated wax comprises one or more C₁₈₊ LAOs, and the one or more C₁₈₊ LAOs have a kinematic viscosity (ASTM D-445) of about 4 cSt or less at 100° C.

Embodiment 18. The tire of Embodiment 16 or Embodiment 17, wherein at least a majority of the one or more C₁₈₊ LAOs comprise C₂₀-C₂₄ LAOs, or C₂₄₊ LAOs.

Embodiment 19. The tire of any one of Embodiments 13-15, wherein the unsaturated wax comprises one or more LAO dimers formed from C₂₀-C₂₄ LAOs, the one or more LAO dimers having an internal olefin, and the one or more LAO dimers having a kinematic viscosity (ASTM D-445) of about 6.5 cSt or less at 100° C.

Embodiment 20. The tire of any one of Embodiments 13-19, further comprising: at least one anti-ozonant compound.

Embodiment 21. The tire of any one of Embodiments 13-20, further comprising: a paraffinic hydrocarbon wax, a microcrystalline wax, or any combination thereof.

Embodiment 22. The tire of Embodiment 21, wherein the unsaturated wax comprises at least a majority of the at least one wax by mass.

To facilitate a better understanding of the embodiments of the present disclosure, the following examples of preferred or representative embodiments are given. In no way should the following examples be read to limit, or to define, the scope of the invention.

### Examples

LAOs were obtained from a base product containing predominantly C₂₀-C₂₄ LAOs and <7% C₁₈₋ LAOs. C₁₈-C₂₄ and C₂₄₊ LAO fractions were obtained through fractional distillation as overhead and bottoms fractions, respectively. LAO dimerization was conducted by metathesis through exposure of a specified LAO fraction to a metal carbene catalyst, as described hereinafter.

A 1-gallon continuous stirred-tank reactor (CSTR) made of SS316 low carbon stainless steel was used as the metathesis reactor. Prior to use, the reactor was thoroughly flushed and cleaned with dewatered toluene and then flushed with purified LAOs. The reactor was subsequently passivated with hot toluene at about 95° C. by circulating the hot toluene through the system for about 4 to 5 hours. The LAO feeds were degassed inline using vacuum to remove any remaining dissolved gasses. The LAO feeds were further purified by passage through a hybrid adsorbent bed of AZ-300 molecular sieves (Honeywell—UOP) for impurity removal (e.g., sulfur, oxygen, ethylene, peroxides, and other heteroatoms). The AZ-300 was pre-activated under N2 at 250° C. for about 8 hours prior to use.

Olefin metathesis was conducted in the presence of a metal carbene catalyst such as Grubbs Catalyst™ 2nd Generation (Gr II) (MW=849 g/mol), Hoveyda-Grubbs Catalyst™ 2nd Generation (HGr II) (MW=627 g/mol), or Schrock Mo carbene catalyst. The metal carbene catalysts were used either in solution (previously dissolved in toluene), as a dry powder, or as a slurry mixed with SPECTRASYN™ 4, a polyalphaolefin synthetic basestock (ExxonMobil Chemicals), also referred to as a Group IV base oil according to the API Base Oil Classification system, without any prior activation process. Homogeneous catalyst solutions were prepared in a glove box under N2 at room temperature by dissolving the metal carbene catalyst (initially in a powder form) in purified, dewatered toluene. The catalyst solutions were protected from moisture and stored at about 4° C. in a refrigerator. Catalyst suspensions were also prepared using, for example, the metal carbene catalyst powder dispersed in a low viscosity polyalphaolefin (e.g., viscosity of 2-10 cSt, such as 2, 4 or 6 cSt), or a hydrogenated olefin dimer, such as, for example, a hydrogenated C₂₆ dimer (prepared from a C₁₄ LAO via a metathesis reaction according to the disclosure herein, followed by hydrogenation). Aromatic solvents, such as toluene, may be excluded from the reaction by using a polyalphaolefin catalyst dispersant.

The catalyst solution in toluene was delivered sub-surface to the reactor via a dip tube using a dedicated metering pump. The catalyst solution was stirred continuously in a separate vessel prior to delivery. Reactions were conducted at a temperature of about 60° C. to about 75° C. at a pressure of about 10-25 psi. The reaction temperature was usually limited to about 60° C. to about 65° C. to limit double bond migration.

Ethylene produced during the metathesis reaction was removed from the reactor while continuing to form dimer. Ethylene removal was accomplished with N2 sparging at a rate of about 2-3 L/min. Any remaining transition metal residues and catalyst debris present in the finished product were removed using silica, Celite®, or other filtration media. Unconverted monomers and other light products were removed by distillation of the reactor effluent to afford purified linear olefin dimers.

Table 1 summarizes the physical properties of various commercial waxes commonly used in rubber blends in comparison to the LAOs and LAO dimers produced as above.

TABLE 1

| | Average | | | | |
|---|---|---|---|---|---|
| | Number | Average | | Kinematic | |
| | of | Molecular | Melting | Viscosity | Needle |
| | Carbon | Weight | Point | at 100° C. | Penetration |
| Sample | Atoms | (g/mol) | (° C.) | (cSt) | Depth (mm) |
| Test Method | | | (DSC) | ASTM D445 | ASTM D1321 |
| Commercial | 35 | 510 | 72 | 5 | 15 |
| Paraffin Wax | | | | | |
| Commercial | 47 | 730 | 80 | 15 | 20 |
| Microcrystalline | | | | | |
| wax | | | | | |
| C₂₀-C₂₄ LAOs | 22 | 280 | 30 | 2 | ND |
| (90% C₂₀/C₂₂ | | | | | |
| LAOs) | | | | | |
| C₂₄₊ LAOs | 26 | 408 | 56 | 3.8 | 33 |
| (56% | | | | | |
| C₂₄/C₂₆/C₂₈ | | | | | |
| LAOs) | | | | | |
| C₃₈-C₄₆ LAO | 38 | 532 | 58 | 6.3 | 35 |
| dimers obtained | | | | | |
| from C₂₀-C₂₄ | | | | | |
| LAOS | | | | | |

Table 2 below shows the composition details of various rubber blends prepared from the foregoing waxes. In Table 2, 6-PPD is N-(1,3-dimethylbutyl)-N′-phenyl-p-phenylenediamine (anti-ozonant), and TMQ is 2,2,4-trimethyl-1,2-dihydroquinoline (anti-oxidant).

TABLE 2

| | Sample No. | | | | | | | |
|---|---|---|---|---|---|---|---|---|
| | 1 | 2 | | | | | | |
| | (pos. | (pos. | | | | | | |
| | control) | control) | 3 | 4 | 5 | 6 | 7 | 8 |
| Component | (part per hundred rubber-phr) | | | | | | | |
| Natural Rubber | 50 | 50 | 50 | 50 | 50 | 50 | 50 | 50 |
| Butadiene Rubber | 50 | 50 | 50 | 50 | 50 | 50 | 50 | 50 |
| Carbon Black | 45 | 45 | 45 | 45 | 45 | 45 | 45 | 45 |
| Naphthenic Oil | 5 | 5 | 5 | 5 | 5 | 5 | 5 | 5 |
| 6-PPD | 4 | 2 | 4 | 2 | 2 | 4 | 2 | 2 |
| TMQ | 2 | 2 | 2 | 2 | 2 | 2 | 2 | 2 |
| Aliphatic | 3 | 3 | 3 | 3 | 3 | 3 | 3 | 3 |
| Hydrocarbon | | | | | | | | |
| Tackifier | | | | | | | | |
| ZnO | 4 | 4 | 4 | 4 | 4 | 4 | 4 | 4 |
| Stearic Acid | 2 | 2 | 2 | 2 | 2 | 2 | 2 | 2 |
| Paraffin Wax | 1 | 1 | — | — | — | — | — | — |
| Microcrystalline | 1 | 1 | — | — | — | — | — | — |
| Wax | | | | | | | | |
| C₂₀-C₂₄ LAO Wax | — | — | — | — | — | 2 | 2 | 4 |
| C₂₄₊ LAO Wax | — | — | — | — | — | — | — | — |
| C₂₀-C₂₄ LAO | — | — | 2 | 2 | 4 | — | — | — |
| Dimer Wax | | | | | | | | |

| | Sample No. | | | | | | |
|---|---|---|---|---|---|---|---|
| | | | | | | | 15 |
| | | | | | | | (neg. |
| | 9 | 10 | 11 | 12 | 13 | 14 | control |
| Component | (part per hundred rubber-phr) | | | | | | |
| Natural Rubber | 50 | 50 | 50 | 50 | 50 | 50 | 50 |
| Butadiene Rubber | 50 | 50 | 50 | 50 | 50 | 50 | 50 |
| Carbon Black | 45 | 45 | 45 | 45 | 45 | 45 | 45 |
| Naphthenic Oil | 5 | 5 | 5 | 5 | 5 | 5 | 5 |
| 6-PPD | 4 | 2 | 2 | 2 | 2 | 2 | 4 |
| TMQ | 2 | 2 | 2 | 2 | 2 | 2 | 2 |
| Aliphatic | 3 | 3 | 3 | 3 | 3 | 3 | 3 |
| Hydrocarbon | | | | | | | |
| Tackifier | | | | | | | |
| ZnO | 4 | 4 | 4 | 4 | 4 | 4 | 4 |
| Stearic Acid | 2 | 2 | 2 | 2 | 2 | 2 | 2 |
| Paraffin Wax | — | — | — | — | — | — | — |
| Microcrystalline | — | — | — | — | — | — | — |
| Wax | | | | | | | |
| C₂₀-C₂₄ LAO Wax | — | — | — | — | 2 | 2 | — |
| C₂₄₊ LAO Wax | 2 | 2 | 4 | 2 | 2 | — | — |
| C₂₀-C₂₄ LAO Dimer | — | — | — | 2 | — | 2 | — |
| Wax | | | | | | | |

Each of the foregoing rubber blends was further blended with 0.8 phr TBBS (N-t-butyl-benzothiazole sulfonamide, accelerator) and 1.8 phr soluble sulfur for vulcanization. Vulcanization was conducted under standard conditions over 5 minutes of mixing time at a temperature not exceeding 140° C.

Physical property testing was conducted upon the rubber vulcanized samples formulated as above. Testing data is summarized in Table 3 below.

TABLE 3

| | Sample No. | | | | | | | |
|---|---|---|---|---|---|---|---|---|
| | 1 | 2 | | | | | | |
| | (pos. | (pos. | | | | | | |
| | control) | control) | 3 | 4 | 5 | 6 | 7 | 8 |
| Mooney Viscosity | 39 | 40 | 39 | 40 | 38 | 38 | 40 | 37 |
| (Mooney Units) | | | | | | | | |
| Mooney Scorch | 22.5 | 24.1 | 22.9 | 23.7 | 24.7 | 22.5 | 24.5 | 24.4 |
| (min) | | | | | | | | |
| Tc90 (min) | 5.3 | 5.3 | 5.2 | 5.4 | 5.4 | 5.2 | 5.3 | 5.4 |
| Original Tensile | 18.6 | 19.3 | 17.7 | 18.0 | 18.9 | 17.1 | 17.0 | 18.7 |
| Strength (MPa) | | | | | | | | |
| Aged Tensile | 10.2 | 8.8 | 8.4 | 8.0 | 8.6 | 8.4 | 9.5 | 9.9 |
| Strength (MPa) | | | | | | | | |
| Original Tear | 62.1 | 48.1 | 69.8 | 70.4 | 65.3 | 73.0 | 57.9 | 65.6 |
| Test (N/mm) | | | | | | | | |
| Aged Tear Test | 31.7 | 31.9 | 33.9 | 33.2 | 30.0 | 34.1 | 31.4 | 36.3 |
| (N/mm) | | | | | | | | |
| Original Hardness | 53 | 54 | 54 | 55 | 55 | 53 | 54 | 53 |
| (Shore A units) | | | | | | | | |
| Aged Hardness | 64 | 66 | 65 | 66 | 65 | 65 | 66 | 65 |
| (Shore A units) | | | | | | | | |
| Peel Adhesion | 18.5 | 18.6 | 22.7 | 20.2 | 27.9 | 30.3 | 18.4 | 19.0 |
| (kgf/cm) | | | | | | | | |
| Abrasion | 212 | 211 | 221 | 209 | 232 | 212 | 198 | 249 |
| Resistance Index | | | | | | | | |
| (%) | | | | | | | | |
| Crack Growth | 25.0 | 25.0 | 25.0 | 24.7 | 25.0 | 25.0 | 24.6 | 23.9 |
| After 100K Cycles | | | | | | | | |
| (mm) | | | | | | | | |
| Crack Growth | 25.0 | 25.0 | 25.0 | 24.8 | 25.0 | 25.0 | 24.8 | 24.4 |
| after 200K Cycles | | | | | | | | |
| (mm) | | | | | | | | |
| Crack Initiation | 0 | 0 | 0 | 0 | 0 | 0 | 0 | 0 |
| After 100K Cycles | | | | | | | | |
| (mm) | | | | | | | | |
| Crack Initiation | 0 | 0 | 0 | 3.2 | 0 | 0 | 0 | 0 |
| After 200K Cycles | | | | | | | | |
| (mm) | | | | | | | | |
| Average FTFT | 22.3 | 22.2 | 40.8 | 17.0 | 27.4 | 20.8 | 26.3 | 27.3 |
| (10³ cycles) | | | | | | | | |

| | Sample No. | | | | | | |
|---|---|---|---|---|---|---|---|
| | | | | | | | 15 |
| | | | | | | | (neg. |
| | 9 | 10 | 11 | 12 | 13 | 14 | control) |
| Mooney Viscosity | 38 | 40 | 38 | 38 | 37 | 38 | 40 |
| (Mooney Units) | | | | | | | |
| Mooney Scorch | 23.3 | 24.8 | 24.7 | 25.4 | 24.7 | 24.7 | 22.2 |
| (min) | | | | | | | |
| Tc90 (min) | 5.3 | 5.5 | 5.3 | 5.6 | 5.5 | 5.4 | 5.2 |
| Original Tensile | 18.4 | 18.3 | 18.0 | 19.1 | 17.2 | 16.8 | 17.3 |
| Strength (MPa) | | | | | | | |
| Aged Tensile | 9.4 | 10.5 | 9.0 | 8.7 | 10.5 | 9.4 | 9.4 |
| Strength (MPa) | | | | | | | |
| Original Tear | 60.1 | 75.6 | 67.6 | 71.2 | 64.2 | 50.4 | 62.7 |
| Test (N/mm) | | | | | | | |
| Aged Tear Test | 34.3 | 35.1 | 35.4 | 33.3 | 29.0 | 32.2 | 34.3 |
| (N/mm) | | | | | | | |
| Original Hardness | 53 | 53 | 53 | 52 | 54 | 54 | 55 |
| (Shore A units) | | | | | | | |
| Aged Hardness | 64 | 65 | 64 | 64 | 64 | 65 | 64 |
| (Shore A units) | | | | | | | |
| Peel Adhesion | 28.2 | 45.1 | 41.8 | 34.7 | 18.8 | 35.4 | 32.9 |
| (kgf/cm) | | | | | | | |
| Abrasion | 205 | 251 | 254 | 239 | 256 | 236 | 216 |
| Resistance Index | | | | | | | |
| (%) | | | | | | | |
| Crack Growth | 24.6 | 24.3 | 25.0 | 24.8 | 24.6 | 25.0 | 25.0 |
| After 100K Cycles | | | | | | | |
| (mm) | | | | | | | |
| Crack Growth | 24.9 | 25.0 | 25.0 | 25.0 | 25.0 | 25.0 | 25.0 |
| after 200K Cycles | | | | | | | |
| (mm) | | | | | | | |
| Crack Initiation | 0 | 2.6 | 0.8 | 0 | 0 | 0 | 0 |
| After 100K Cycles | | | | | | | |
| (mm) | | | | | | | |
| Crack Initiation | 9.9 | 15.6 | 6.9 | 6.2 | 0 | 3.4 | 17.4 |
| After 200K Cycles | | | | | | | |
| (mm) | | | | | | | |
| Average FTFT | 40.1 | 36.9 | 39.5 | 42.6 | 42.2 | 40.9 | 23 |
| (10³ cycles) | | | | | | | |

The positive controls (Samples 1 and 2) and the negative control (Sample 15) had comparable physical properties. However, the negative control exhibited poorer ozone 5 resistance (see below). The LAOs or LAO dimer waxes afforded physical properties that were at least comparable to, if not superior to, the corresponding positive control in various instances. For example, Mooney Scorch values for most of the experimental samples exceeded the values of both positive controls, but without substantially compromising other physical properties. Mooney Scorch performance was especially good for the C₂₆₊ LAOs (Samples 9-11) and mixtures of different types of LAO-derived waxes (Samples 12-14). These samples also tended to afford a good balance of Tear Test performance, Peel Adhesion, and Abrasion Resistance. LAO dimers (Samples 3-5) and C₂₀-C₂₄ LAOs (Samples 6-8) tended to afford rubber blends with good Crack Growth and Crack Initiation performance.

The above samples were also exposed to ozone (50 parts ozoneaa per hundred million air by volume, pphm) for 150 hours at 40° C., and visual changes to the samples were noted. The positive control samples (Samples 1 and 2) exhibited little visual change after exposure to ozone. The negative control (Sample 15), in contrast, showed visible cracking following ozone exposure. Samples containing the LAO dimer (Samples 3-5) exhibited similar performance to the positive controls, with very little visible change being observed following ozone exposure.

Many alterations, modifications, and variations will be apparent to one having ordinary skill in the art in light of the foregoing description without departing from the spirit or scope of the present disclosure and that when numerical limits and numerical upper limits are listed herein, ranges from any lower limit to any upper limit are contemplated.

All documents described herein are incorporated by reference herein for purposes of all jurisdictions where such practice is allowed, including any priority documents and/or testing procedures to the extent that they are not inconsistent with this text. As is apparent from the foregoing general description and the specific embodiments, while forms of the disclosure have been illustrated and described, various modifications may be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is:

1. A rubber blend comprising:
at least one rubber compound; and
at least one wax mixed with the at least one rubber compound;
wherein the at least one wax comprises an unsaturated wax.

2. The rubber blend of claim 1, wherein the at least one rubber compound comprises natural rubber, synthetic polyisoprene, butadiene rubber, butyl rubber, bromobutyl rubber, chlorobutyl rubber, ethylene-propylene-diene monomer rubber, a brominated copolymer of isobutylene and p-methylstyrene, or any combination thereof.

3. The rubber blend of claim 1, wherein the at least one rubber compound comprises a mixture of natural rubber and butadiene rubber.

4. The rubber blend of claim 1, wherein the unsaturated wax comprises one or more of C₁₈₊ linear alpha olefins (LAOs); LAO dimers formed from C₁₈₊ LAOs, the LAO dimers having an internal olefin; or any combination thereof.

5. The rubber blend of claim 1, wherein the unsaturated wax comprises one or more C₁₈₊ LAOs, and the one or more C₁₈₊ LAOs have a kinematic viscosity (ASTM D-445) of about 4 cSt or less at 100° C.

6. The rubber blend of claim 5, wherein at least a majority of the one or more C₁₈₊ LAOs comprise C₂₀-C₂₄ LAOs, or C₂₄₊ LAOs.

7. The rubber blend of claim 1, wherein the unsaturated wax comprises one or more LAO dimers formed from C₂₀-C₂₄ LAOs, the one or more LAO dimers having an internal olefin, and the one or more LAO dimers having a kinematic viscosity (ASTM D-445) of about 6.5 cSt or less at 100° C.

8. The rubber blend of claim 1, further comprising:
at least one anti-ozonant compound.

9. The rubber blend of claim 1, further comprising:
a paraffinic hydrocarbon wax, a microcrystalline wax, or any combination thereof.

10. The rubber blend of claim 9, wherein the unsaturated wax comprises at least a majority of the at least one wax by mass.

11. A rubber article comprising the rubber blend of claim 1.

12. The rubber article of claim 11, wherein the rubber article is selected from the group consisting of a hose, a belt, a tube, a flap, an O-ring, a tire, and a gasket.

13. A tire comprising:
a sidewall formed from a rubber blend that is vulcanized and comprises:
at least one rubber compound; and
at least one wax mixed with the at least one rubber compound;
wherein the at least one wax comprises an unsaturated wax.

14. The tire of claim 13, wherein the at least one rubber compound comprises natural rubber, synthetic polyisoprene, butadiene rubber, butyl rubber, bromobutyl rubber, chlorobutyl rubber, ethylene-propylene-diene monomer rubber, a brominated copolymer of isobutylene and p-methylstyrene, or any combination thereof.

15. The tire of claim 13, wherein the at least one rubber compound comprises a mixture of natural rubber and butadiene rubber.

16. The tire of claim 13, wherein the unsaturated wax comprises one or more of C₁₈₊ linear alpha olefins (LAOs); LAO dimers formed from C₁₈₊ LAOs, the LAO dimers having an internal olefin; or any combination thereof.

17. The tire of claim 13, wherein the unsaturated wax comprises one or more C₁₈₊ LAOs, and the one or more C₁₈₊ LAOs have a kinematic viscosity (ASTM D-445) of about 4 cSt or less at 100° C.

18. The tire of claim 17, wherein at least a majority of the one or more C₁₈₊ LAOs comprise C₂₀-C₂₄ LAOs, or C₂₄₊ LAOs.

19. The tire of claim 13, wherein the unsaturated wax comprises one or more LAO dimers formed from C₂₀-C₂₄ LAOs, the one or more LAO dimers having an internal olefin, and the one or more LAO dimers having a kinematic viscosity (ASTM D-445) of about 6.5 cSt or less at 100° C.

20. The tire of claim 13, further comprising:
at least one anti-ozonant compound.

21. The tire of claim 13, further comprising:
a paraffinic hydrocarbon wax, a microcrystalline wax, or any combination thereof.

22. The tire of claim 21, wherein the unsaturated wax comprises at least a majority of the at least one wax by mass.
